(19) United States
(12) Patent Application Publication
(10) Pub. No.: US 2003/0191209 A1
(43) Pub. Date: Oct. 9, 2003

(54) Dental compositions

(76) Inventors: Yue Hugh Guan, South Yorkshire (GB); Terence Henry Lilley, South Yorkshire (GB)

Correspondence Address: ROTHWELL, FIGG, ERNST & MANBECK, P.C., 1425 K STREET, N.W., SUITE 800, WASHINGTON, DC, 20005, US

(21) Appl. No.: 10/333,692

(22) PCT Filed: Jul. 25, 2001
(86) PCT No.: PCT/EP01/08606

(51) Int. Cl. C08K 3/00

(52) U.S. Cl. 523/105

(57) ABSTRACT

Compositions for inhibiting the adherence and formation of plaque and/or stains on the teeth, said compositions contain two poloxamers selected from a first group of poloxamers having a melting point in the range 48 to 58 degrees C. and having a HLB value in the range 22 to 29 and a second group of poloxamers having a melting point in the range 27 to 35 degrees C. and

This invention discloses dental compositions which prevent bacteria, plaque and stains from adhering to teeth.

Dental plaque is a general term for the complex microbial community existing on the tooth surface, embedded in a matrix of polymers of bacterial and salivary origin. Plaque that becomes calcified is referred to as calculus. Plaque has been implicated as the cause of caries, gingivitis and periodontal disease.

The control of plaque is very important since it has been implicated as the main cause of dental diseases. The main approaches have been mechanical plaque removal e.g. tooth-brushing or flossing or the use of chemical anti-microbial agents in oral care products such as toothpaste and mouthwash. Whilst toothbrushing easily removes plaque this is only a short term measure as the plaque rapidly recolonises the tooth surfaces and indeed may not be entirely removed from the more inaccessible areas such as fissures, interproximal spaces or the gingival crevice.

So however efficiently the teeth are cleaned, plaque build up starts almost from cessation of brushing. Bacteria rarely come into contact with bare enamel. As soon as the tooth surface is cleaned, salivary glycoproteins are adsorbed onto the surface forming the acquired salivary pellicle. Large numbers of bacteria are found in saliva (up to 10⁸ CFU ml⁻¹) which, unless swallowed, are likely to come into contact with a tooth surface and can initiate colonisation of that surface.

Coccal bacterial species such as S. sanguis, S. oralis and S. mitis are adsorbed onto the pellicle coated enamel within about 2 hours after cleaning. Other pioneer species such as Actinomyces are also found but obligatory anaerobic bacterial species are rarely detected at this stage. These primary colonising populations multiply, forming micro-colonies which become embedded in bacterial extracellular slimes and polysaccharides together with additional layers of adsorbed salivary proteins and glycoproteins. Growth of individual micro-colonies eventually results in the development of a confluent film of micro-organisms. The growth rates of the bacteria are fastest during this early period with doubling times from 1-3 hours having been calculated. As the plaque develops into a biofilm, metabolism by the pioneer species creates conditions suitable for colonisation by species with more demanding atmospheric and nutritional requirements. Also additional nutrients become available and the diversity of microbial cells in the microflora increases both in terms of the morphological types and the numbers of species.

Any method of oral hygiene needs to inhibit this rapid build up of plaque. Plaque control using antimicrobial agents has been a successful approach for many years. There may, however, be consequences from long term unsupervised use of these types of materials in oral care products such as disruption of the ecology of the oral microflora which may lead to the opportunistic overgrowth of more pathogenic species or to the development of resistant strains of organisms. An alternative approach is to modify the tooth surface coating and to make this less likely to form a good substrate for the initial colonisation of organisms.

As well as plaque control, it is expected that a dental composition will keep teeth looking nice, in particular by preventing staining. Extrinsic dental staining results from food, drink, tobacco, chromogenic bacteria and airborne particles. The exact mechanism of tooth staining is still subject to further investigations. However, it is widely thought to be dependent on the affinities of the chromogenic compounds for either the tooth surface, acquired pellicle, plaque and calculus present on the tooth surface.

After cleaning, proteins from saliva rapidly become deposited on the enamel surface to form the acquired salivary pellicle. As with plaque build-up, this pellicle forms a good substrate for the binding of compounds that are either coloured or become coloured due to chemical reactions such as the Maillard reaction.

Attempts to form films on teeth to prevent staining and decay have been previously documented.

U.S. Pat. No. 5,032,387 discloses a portable pump which dispenses amounts of a composition as a spray. The product is formulated as a spray to allow use as frequently as necessary. The composition contains cleaning agents such as surfactants and coating agents such as polymers and waxes. The coating agents have no solubility in water. These form a film over the teeth and prevent the adherence of plaque.

U.S. Pat. No. 5,645,841 teaches oral rinses containing a dispersion of silicone in a surfactant. The silicone is insoluble in the surfactant, but when dispersed in water, forms a coating on surfaces of the mouth. These oral rinses give improved antiplaque and antigingivitis activity. This is achieved as the coating acts a reservoir for various actives used to treat such conditions. Because of this, less ethanol is needed in the oral rinse to solubilise said actives.

WO-A-9414405 discloses a dentifrice containing a silicone oil. The oil enhances the polishing effect and shine of the teeth and reduces the extent to which the surfaces of the teeth are abraded. The silicone oil forms a film over the teeth. Any pellicle layer formed over this film is much easier to remove than normal plaque.

EP-A-839516 discloses dentifrices containing fatty acid triglycerides particularly capric and caprylic triglycedrides to reduce the adhesion of bacteria and plaque to the tooth surface.

This prior art teaches the application of water-insoluble hydrophobic molecules to inhibit the adherence and formation of plaque. Hydrophobic molecules of this type are extremely difficult to formulate into acceptable products. Complex emulsion systems are often required to produce a well mixed, stable and usable formulation.

We have now found that the use of a combination of selected water-soluble block copolymers of polyoxyethylene/polyoxypropylene which have a structure with the polyoxypropylene block being sandwiched between two polyoxyethylene blocks inhibits the adherence and formation of plaque and/or stains on the teeth. Such EO/PO/EO block copolymers are known generically as poloxamers and are available commercially, for example from BASF Corporation under the trade name Pluronic. Examples of the block copolymers sold under this trade name are given below. The data given is the molecular weight (MW), the melting point in degrees Celsius (M.p.), the HLB value.(HLB) and the percentage of ethylene oxide present in the copolymer by weight (%EO)

| Trade | | | | | | | | |
|---|---|---|---|---|---|---|---|---|
| Desig- | | | | | | | | |
| nation | F68 | F77 | F87 | F88 | F98 | F127 | | |
| MW | 8400 | 6600 | 7700 | 11400 | 13000 | 12600 | | |
| M.p. | 52 | 48 | 49 | 54 | 58 | 56 | | |
| HLB | 29 | 25 | 24 | 28 | 28 | 22 | | |
| % EO | 80 | 70 | 70 | 180 | 80 | 70 | | |
| Trade | | | | | | | | |
| Designation | P65 | P84 | P85 | P103 | P104 | P105 | P108 | P123 |
| MW | 3400 | 4200 | 4600 | 4950 | 5900 | 6500 | 14600 | 5750 |
| M.p. | 27 | 34 | 34 | 30 | 32 | 35 | 57 | 31 |
| HLB | 17 | 14 | 16 | 9 | 13 | 15 | 28 | 8 |
| % EO | 50 | 40 | 50 | 30 | 40 | 50 | 80 | 30 |

The present invention provides compositions for inhibiting the adherence and formation of plaque and/or stains on the teeth, said compositions containing two poloxamers selected from a first group of poloxamers having a melting point in the range 48 to 58 degrees C. and having a HLB value in the range 22 to 29 and a second group of poloxamers having a melting point in the range 27 to 35 (for example 30 to 35) degrees C. and having a HLB value in the range 8 to 1.7 (for example 8 to 15). Both poloxamers may be selected from the same group or the poloxamers may be selected from different groups. Such block copolymers are present at 0.1 to 30%, preferably 0.5 to 20%, most preferably 1 to 15% by weight of the total composition.

Suitable combinations of poloxamers include:

Pluronic F77+Pluronic F98

Pluronic F68+Pluronic F98

Pluronic F87+Pluronic F98

Pluronic P123+Pluronic F77

Pluronic P104+Pluronic F127

Pluronic F77+Pluronic F68

Pluronic P103+Pluronic P105

Pluronic P105+Pluronic F88

Pluronic F68+Pluronic F88

Pluronic F87+Pluronic F68

Pluronic P103+Pluronic F77

Pluronic P103+Pluronic F98

Pluronic P103+Pluronic F88

Pluronic P105+Pluronic F77

Pluronic P103+Pluronic F68

Pluronic P104+Pluronic F98

Pluronic P85+Pluronic F88

Pluronic F87+Pluronic F88

Pluronic P103+Pluronic P104

Pluronic P65+Pluronic P108

Pluronic P85+Pluronic F68

Pluronic P85+Pluronic F77

Pluronic P85+Pluronic F98

Pluronic P85+Pluronic P84

Pluronic P85+Pluronic F87

Pluronic F77+Pluronic F87

Pluronic F88+Pluronic F98

Pluronic P105+Pluronic F108

Pluronic P84+Pluronic P105

Pluronic P84+Pluronic P104

Pluronic P65+Pluronic P104

The ratio of the amounts of the two poloxamers may be in the range 90:10 to 10:90, preferably 80:20 to 20:80, more preferably 65:35 to 35:65, even more preferably 60:40 to 40:60, most preferably around 50:50.

The dental composition may be formulated as a toothpaste, mouthrinse, toothgel, toothpowder, dental tablet or a dental gel and may be formulated in a manner known to those skilled in the art.

Such compositions may, as appropriate, contain conventional materials such as, for example, humectants, surfactants, gelling agents, abrasives, fluoride sources, desensitising agents, flavourings, colourings, sweeteners, preservatives, structuring agents, bactericides, an -tartar agents, chelating agents, whitening agents, vitamins, anti-plaque agents and any other therapeutic actives.

Suitable abrasives include particulate cellulose, silica, alumina, insoluble metaphosphates, calcium carbonate, dicalcium phosphate (in dihydrate and anhydrous forms), calcium pyrophosphate, natural and synthetic clays, and particulate thermosetting polymerised resins selected from melamine-ureas, melamine-formaldehydes, urea-formaldehydes, melamine-urea-formaldehydes, cross-linked epoxides, melamines, phenolics and cross-linked polyesters.

Suitable silica abrasives include the hydrated silicas, particularly those available under the trade names ‘Sident’ from Degussa AG, ‘Zeodent’ from J M Huber Corporation, ‘Sorbosil’ from Crosfield UK and Tixosil from Rhodia. Suitably, the particulate cellulose is highly purified cellulose such as that available under the trade names ‘Elcema’ from Degussa AG.

Suitable humectants for use in dentifrice compositions include polyhydric alcohols such as xylitol, sorbitol, glycerol, propylene glycol and polyethylene glycols. Mixtures of glycerol and sorbitol or sorbitol and xylitol are particularly effective. A humectant helps to prevent dentifrice compositions from hardening on exposure to air, and may also provide a moist feel, smooth texture, flowability and a desirable sweetness in the mouth. Suitably, such humectants may comprise from about 0-85% preferably from about 0-60% by weight of the oral hygiene composition.

Suitable surfactants for use in dentifrices, mouthwashes etc. are usually water-soluble organic compounds and may be anionic, non-ionic, cationic or amphoteric species. The surfactant should preferably be reasonably stable and able to produce a foam in use.

Anionic surfactants include the water soluble salts of C10-C18 alkyl sulphates (e.g. sodium lauryl sulphates), water-soluble salts of C10-C18 ethoxylated alkyl sulphates, water-soluble salts of C10-C18 alkyl sarcosinates, the water soluble salts of sulfonated monoglycerides of C10-C18 fatty acids (e.g. sodium coconut monoglyceride sulfonates), alkyl aryl sulfonates (e.g. sodium dodecyl benzene sulfonate), sodium salts of the coconut fatty acid amide of N-methyltaurine and sodium salts of long chain olefin sulfonates (e.g. sodium C14-C16 olefin sulfonate).

Non-ionic surfactants suitable for use in oral compositions include the products of alkylene oxide groups with aliphatic or alkylaromatic species, and may be for example, polyethylene oxide condensates of alkyl phenols, ethylene oxide/ethylene diamine copolymers, ethylene oxide condensates of aliphatic alcohols, long chain tertiary amine oxides, long chain tertiary phosphine oxides, long chain dialkyl sulfoxides and mixtures thereof. Alternatives include ethoxylated sorbitan esters such as those available from ICI under the trade name ‘Tween’.

Cationic surfactants are generally quaternary ammonium compounds having at least one C8-C18 alkyl or aryl chain and include, for example, lauryl trimethylammonium chloride, cetyl trimethylammonium bromide, cetyl pyridinium chloride, diisobutylphenoxyethoxyethyidimethylbenzylammonium chloride, coconut alkyl trimethylammonium nitrate and cetyl pyridinium fluoride.

Also useful are benzyl ammonium chloride, benzyl dimethylstearylammonium chloride, and tertiary amines having one C1-C18 hydrocarbon group and two (poly)oxyethylene groups.

Amphoteric surfactants may be aliphatic secondary and tertiary amines comprising aliphatic species which may be branched or unbranched, and in which one of the aliphatic species is a C8-C18 species and the other contains an anionic hydrophilic group, for example, sulfonate, carboxylate, sulphate, phosphonate or phosphate. Examples of quaternary ammonium compounds are the quaternized imidazole derivatives available under the trade name ‘Miranol’ from the Miranol Chemical Company. Other amphoteric surfactants that may be employed are fatty acid amido alkyl betaines where one alkyl group is commonly C10-C12 such as cocoamido propyl betaine, for example Tego Betain supplied by T H Goldschmidt.

Suitably the surfactant is included in an amount from 0-20%, preferably 0-10%, most preferably 0.5-3% by weight of the oral hygiene composition.

Structuring agents may be required in, for example, dentifrices and gums to provide desirable textural properties and ‘mouthfeel’. Suitable agents include natural gum binders such as gum tragacanth, xanthan gum, gum karaya and gum arabic, seaweed derivatives such as Irish moss and alginates, smectite clays such as bentonite or hectorite, carboxyvinyl polymers and water-soluble cellulose derivatives such as hydroxyethyl cellulose and sodium carboxymethyl cellulose. Improved texture may also be achieved, for example, by including colloidal magnesium aluminium silicate. Suitably, the structuring agents is included in an amount from 0-5%, preferably 0-3% by weight of the oral hygiene composition.

Fluoride sources suitable for use in all oral hygiene compositions of the present invention include sodium fluoride, zinc fluoride, potassium fluoride, aluminium fluoride, lithium fluoride, sodium monofluorophosphate, stannous fluoride, ammonium fluoride, ammonium bifluoride and amine fluoride.

Preferably, the fluoride source is present in an amount sufficient to provide from about 50 ppm to about 4,000 ppm fluoride ions in the composition. Inclusion of a fluoride source is beneficial, since fluoride ions are known to become incorporated into the hydroxyapatite of tooth enamel, thereby increasing the resistance of the enamel to decay. Fluoride is also now thought to act locally on the tooth enamel, altering the remineralisation-demineralisation balance in the favour of remineralisation. Inclusion of a fluoride source is also desirable when a polyphosphate anti-calculus agent is included, in order to inhibit the enzymatic hydrolysis of such polyphosphates by salivary phosphatase enzymes.

Suitable desensitising agents include, for example, formaldehyde, potassium salts such as potassium nitrate, tripotassium citrate, potassium chloride, potassium bicarbonate and strontium salts such as strontium chloride (suitably as hexahydrate), strontium acetate (suitably as hemihydrate) and also dibasic sodium citrate.

Flavouring agents may be added to increase palatability and may include, for example, menthol, oils of peppermint, spearmint, wintergreen, sassafras and clove. Sweetening agents may also be used, and these include D-tryptophan, saccharin, aspartame, levulose, acesulfam, dihydrochalcones and sodium cyclamate.

Typically, such flavouring agents are included in amounts from 0-5%, preferably from 0-2% by weight of the oral hygiene composition. Colouring agents and pigments may be added to improve the visual appeal of the composition. Suitable colourants include dyes and pigments. A suitable and commonly used pigment is titanium dioxide, which provides a strong white colour.

Suitably, as described above, the compositions of the invention may include further antimicrobial agents as preservative, antibacterial and/or anti-plaque agents. Suitable antimicrobial agents include water-soluble sources of certain metal ions such as zinc, copper and silver such as zinc citrate and silver chloride, the bis-biguanides such as chlorhexidine, aliphatic amines, phenolics such as bromochlorophene and triclosan, salicylanilides and quaternary ammonium compounds such as cetyl pyridinium chloride. Optionally, the formulations may also contain enzymes that will disrupt the pellicle or interfere with bacterial intercellular polysaccharides. Examples would include proteases such as papain and bromelain or dextranases. Natural enzymatic biocidal systems such as a system comprising lactoperoxidase and glucose oxidase may also be employed.

The composition may additionally comprise one or more anti-calculus agents.

Suitable anticalculus agents include zinc salts such as zinc citrate and zinc chloride, polyphosphates and pyrophosphates. Suitable pyrophosphates include the sodium and potassium pyrophosphates, preferably disodium pyrophosphate, dipotassium pyrophosphate, tetrasodium pyrophosphate and tetrapotassium pyrophosphate and mixtures thereof. A preferred source of pyrophosphate is a mixture of tetrasodium pyrophosphate and tetrapotassium pyrophosphate. Suitable polyphosphates include sodium tripolyphosphate.

The invention is illustrated by the following non-limiting examples.

### EXAMPLE 1

### Anti-adherent Toothpaste

| | % w/w |
|---|---|
| Sorbitol (70% soln) | 20.00 |
| Hydrated Silica abrasive | 5.00 |
| Hydrated Silica Thickener | 9.72 |
| Flavour | 0.91 |
| Poloxamer (Pluronic P123) | 5 |
| Poloxamer (Pluronic F77) | 5 |
| Sodium Monofluorophosphate | 0.80 |
| Sodium Saccharin | 0.26 |
| Titanium Dioxide | 0.5 |
| Sodium Carboxymethylcellulose | 0.8 |
| Sodium Lauryl Sulphate | 0.2 |
| Water | qs |

The poloxamers, sodium monofluorophosphate and sodium saccharin were dissolved in water and sorbitol added. Hydrated silica thickener, hydrated silica abrasive, titanium dioxide, sodium carboxymethylcellulose, sodium lauryl sulphate added and mixed under vacuum. Flavour added and bulk mixed under vacuum until homogeneous.

### EXAMPLE 2

### Anti-adherent Toothpaste with Antibacterial Agent

| | % w/w |
|---|---|
| Sorbitol (70% soln) | 20.00 |
| Hydrated Silica abrasive | 5.00 |
| Hydrated Silica Thickener | 9.72 |
| Flavour | 0.91 |
| Poloxamer (Pluronic P123) | 5 |
| Poloxamer (Pluronic F77) | 5 |
| Triclosan | 0.3 |
| Sodium Monofluorophosphate | 0.80 |
| Sodium Saccharin | 0.26 |
| Titanium Dioxide | 0.5 |
| Sodium Carboxymethylcellulose | 0.8 |
| Sodium Lauryl Sulphate | 0.2 |
| Water | qs |

The poloxamers, sodium monofluorophosphate, and sodium saccharin were dissolved in water and sorbitol and sodium polyaspartate added. Hydrated silica thickener, hydrated silica abrasive, titanium dioxide, sodium carboxymethylcellulose, sodium lauryl sulphate added and mixed under vacuum. Triclosan dissolved in flavour and solution added and bulk mixed under vacuum until homogeneous.

The anti-adherence potential of the poloxamer combinations was assessed in vitro in a first set of experiments using a microtitre assay method utilising a conjugated product of biotinylated bacterial cells and avidin alkaline phosphatase which yield a coloured product on reaction with p-nitrophenyl phosphate (pNPP). The absorbance of this coloured product can be measured at 404 nm to give the number of adhered bacterial cells in a biofilm.

A culture of Streptococcus sanguis NCTC 10904 was grown aerobically overnight at 37° C. in brain heart infusion broth under static conditions. The cells were then washed 3 times using sterile Phosphate Buffered Saline (PBS) and pelleted by centrifuge at 8000 g for 6 min. The cells were re-suspended to a density of 6.25×10⁸ cells/ml in PBS. 10 ml of this suspension was mixed with 0.5 ml of N-hydroxysuccinimidobiotin (Sigma H1759) at a concentration of 20 mg/ml in dimethyl sulfoxide and incubated for 1.5 h at ambient temperature. The conjugated cells were washed a further two times with PBS and 150-μl aliquots of biotinylated cells at a density of 2×10⁹ cells/ml were then stored at −70° C. for use in the microtitre assay.

A pellicle was laid down on wells with 250 μl Artificial Saliva followed by 1 hr incubation at 37° C. (The Artificial Saliva contained 0.1% lab-lemco powder, 0.2% yeast extract powder, 0.5% proteose peptone, 0.25% hog gastric mucin, 6.0 mM NaCl, 1.8 mM CaCl2 and 2.7 mM KCl. Prior to use, 125 μl 40% urea aqueous solution was added to each 100 ml of this mixture). 100 μl of the active materials (5% w/w solution in deionised water) were then added and the plates incubated at 37° C. for 1 hour. The wells were then rinsed with 4×250 μl PBS and 100 μl biotinylated S. sanguis suspension added (2×10⁷ cells/ml). Plates were again incubated for 1 hour at 37° C. Wells were again rinsed with 4×250 μl PBS and the biotinylated cells were conjugated with 100 μl avidin alkaline phosphatese (0.5 μl/ml) with bovine serum albumin at 5 mg/ml in PBS prior to 0.5 hour incubation at ambient temperature. The wells were given a final rinse with 4×250 μl PBS before addition of 100 μl pNPP solution (Sigma Fast pNPP tablets Sigma N-2770). The colour was allowed to develop for 0.5 hr at ambient temperature before the solutions were transferred to an uncoated Elisa plate and the absorbance read at 404 nm using a plate reader.

The adherence assays were performed in quadruplicate. Water and capric/caprylic triglyceride were used as negative and positive controls respectively. Uncoated wells were used as a control for assessing bacterial adherence onto the blank surface. Wells without bacterial suspension were used to check the inertness of avidin alkaline phosphatase to the blank surface. Wells containing only pNPP were used to measure the baseline of the assay.

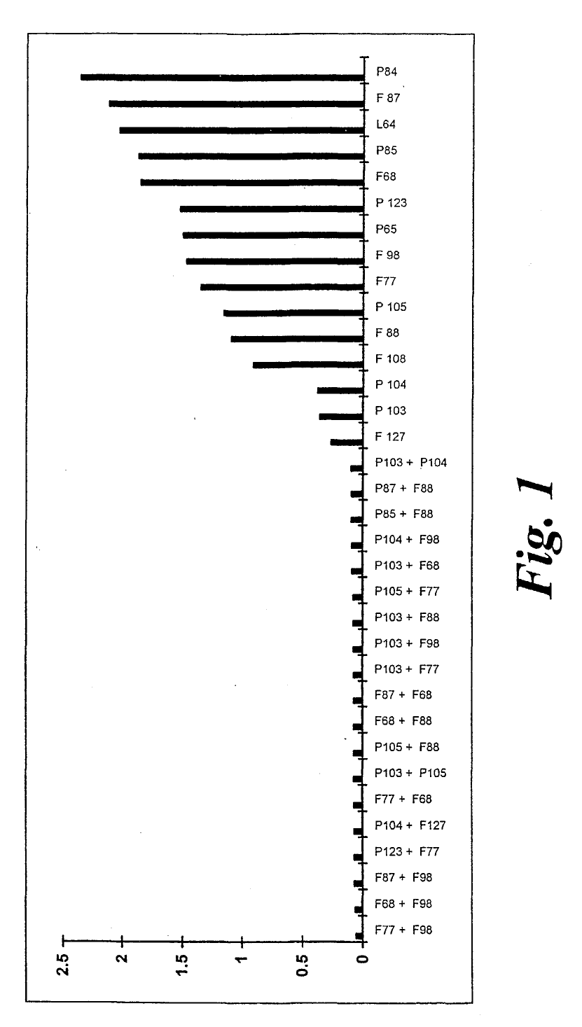

Results for poloxamers alone are shown in Table 1 with results for combinations containing equal amounts of the two poloxamers in Table 2. The results of Tables 1 and 2 are shown graphically in FIG. 1 in which the figures on the vertical axis represent the observed absorbance at 404 nm.

TABLE 1
Absorbance at 404 nm for single Pluronic polymers

| | Absorbance at |
|---|---|
| Material | 404 nm |
| Pluronic F 127 | 0.26125 |
| Pluronic P 103 | 0.35075 |
| Pluronic P 104 | 0.3715 |
| Pluronic F 88 | 1.09175 |
| Pluronic P 105 | 1.15175 |
| Pluronic F77 | 1.34325 |
| Pluronic F 98 | 1.4655 |
| Pluronic P 123 | 1.516 |
| Pluronic F68 | 1.84675 |
| Pluronic P85 | 1.86525 |
| Pluronic F 87 | 2.118 |

TABLE 2
Absorbance at 404 nm for Pluronic combinations

| | Absorbance at |
|---|---|
| Material | 404 nm |
| Pluronic F77 + Pluronic F98 | 0.057 |
| Pluronic F68 + Pluronic F98 | 0.06075 |
| Pluronic F87 + Pluronic F98 | 0.06975 |
| Pluronic P123 + Pluronic F77 | 0.07075 |
| Pluronic P104 + Pluronic F127 | 0.0715 |
| Pluronic F77 + Pluronic F68 | 0.07175 |
| Pluronic P103 + Pluronic P105 | 0.07225 |
| Pluronic P105 + Pluronic F88 | 0.07425 |
| Pluronic F68 + Pluronic F88 | 0.07475 |
| Pluronic F87 + Pluronic F68 | 0.075 |
| Pluronic P103 + Pluronic F77 | 0.07525 |
| Pluronic P103 + Pluronic F98 | 0.077 |
| Pluronic P103 + Pluronic F88 | 0.079 |
| Pluronic P105 + Pluronic F77 | 0.07975 |
| Pluronic P103 + Pluronic F68 | 0.0885 |
| Pluronic P104 + Pluronic F98 | 0.089 |
| Pluronic P85 + Pluronic F88 | 0.09075 |
| Pluronic F87 + Pluronic F88 | 0.09075 |
| Pluronic P103 + Pluronic P104 | 0.099 |

Mean absorbance values for capric/caprylic triglyceride=0.32. Absorbance values less than 0.1 (ie 3 times better than capric/caprylictTriglyceride) indicate an anti-adherence effect.

The data clearly show that combinations of selected EO/PO block copolymers inhibits the adherence of plaque bacteria.

The anti-adherence potential of the poloxamer combinations was assessed in vitro in a second set of experiments using a microtitre assay method utilising a conjugated product of biotinylated bacterial cells and avidin alkaline phosphatase which yield a coloured product on reaction with p-nitrophenyl phosphate (pNPP). The absorbance of this coloured product can be measured at 404 nm to give the number of adhered bacterial cells in a biofilm.

A culture of Streptococcus sanguis NCTC 10904 was grown aerobically overnight at 37° C. in brain heart infusion broth under static conditions. The cells were then washed 3 times using sterile Phosphate Buffered Saline (PBS) and pelleted by centrifuge at 8000 g for 6 min. The cells were re-suspended to a density of 6.25×10⁸ cells/ml in PBS. 10 ml of this suspension was mixed with 0.5 ml of N-hydroxysuccinimidobiotin (Sigma H1759) at a concentration of 20 mg/ml in dimethyl sulfoxide and incubated for 1.5 h at ambient temperature. The conjugated cells were washed a further two times with PBS and 150-μl aliquots of biotinylated cells at a density of 2×10⁹ cells/ml were then stored at −70° C. for use in the microtitre assay.

Flat-bottomed 96-well Elisa PS plates were coated with HA by repeated treatments using a calcifying solution (Schilling et al 1994).

A pellicle was laid down on the HA-coated wells with 250 μl Artificial Saliva followed by 1 hr incubation at 37° C. (The Artificial Saliva contained 0.1% lab-lemco powder, 0.2% yeast extract powder, 0.5% proteose peptone, 0.25% hog gastric mucin, 6.0 mM NaCl, 1.8 mM CaCl2 and 2.7 mM KCl. Prior to use, 125 μl 40% urea aqueous solution was added to each 100 ml of this mixture). 100 μl of the active materials (5% w/w solution in deionised water) were then added and the plates incubated at 37° C. for 1 hour. The wells were then rinsed with 4×250 μl PBS and 100 μl biotinylated S. sanguis suspension added (2×10⁷ cells/ml). Plates were again incubated for 1 hour at 37° C. Wells were again rinsed with 4×250 μl PBS and the biotinylated cells were conjugated with 100 μl avidin alkaline phosphatese (0.5 μl/ml) with bovine serum albumin at 5 mg/ml in PBS prior to 0.5 hour incubation at ambient temperature. The wells were given a final rinse with 4×250 μl PBS before addition of 100 μl pNPP solution (Sigma Fast pNPP tablets Sigma N-2770). The colour was allowed to develop for 0.5 hr at ambient temperature before the solutions were transferred to an uncoated Elisa plate and the absorbance read at 404 nm using a plate reader

The adherence assays were performed in quadruplicate. Water and capric/caprylic triglyceride were used as negative and positive controls respectively. Uncoated wells were used as a control for assessing bacterial adherence onto the blank surface. Wells without bacterial suspension were used to check the inertness of avidin alkaline phosphatase to the blank surface. Wells containing only pNPP were used to measure the baseline of the assay.

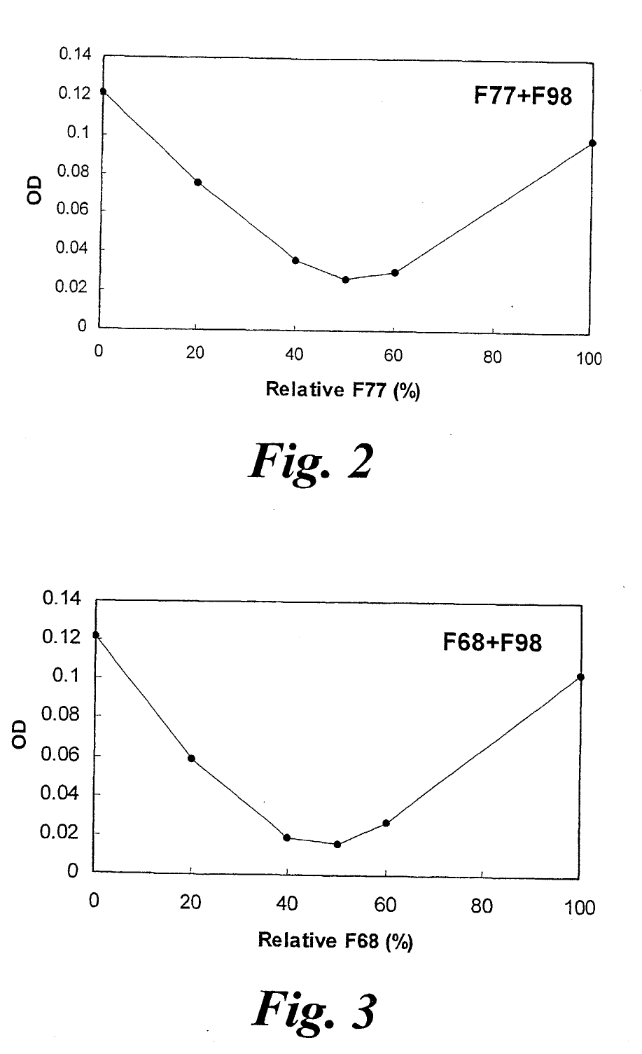

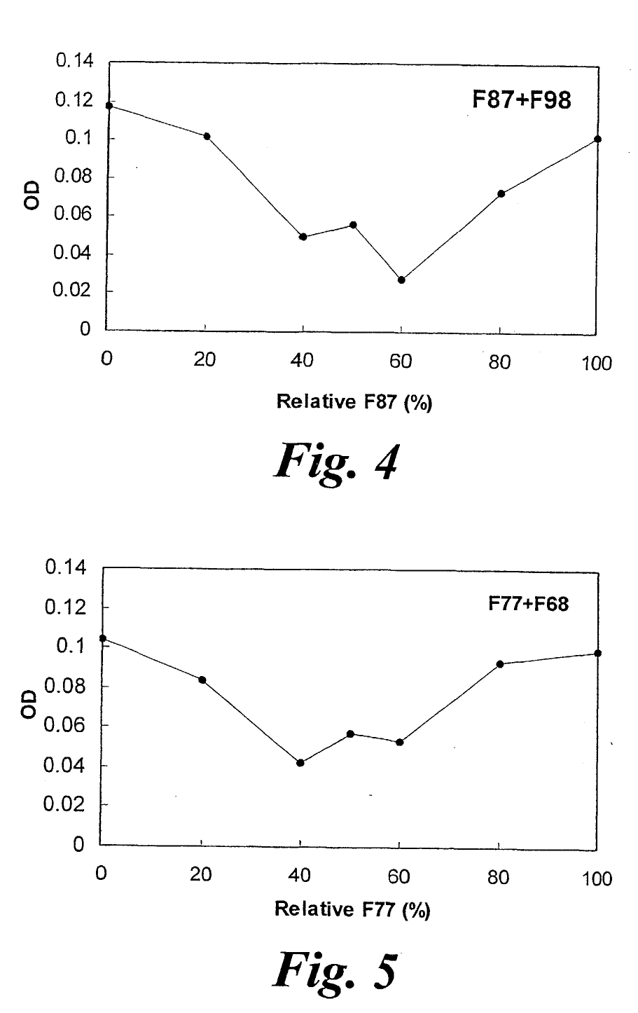

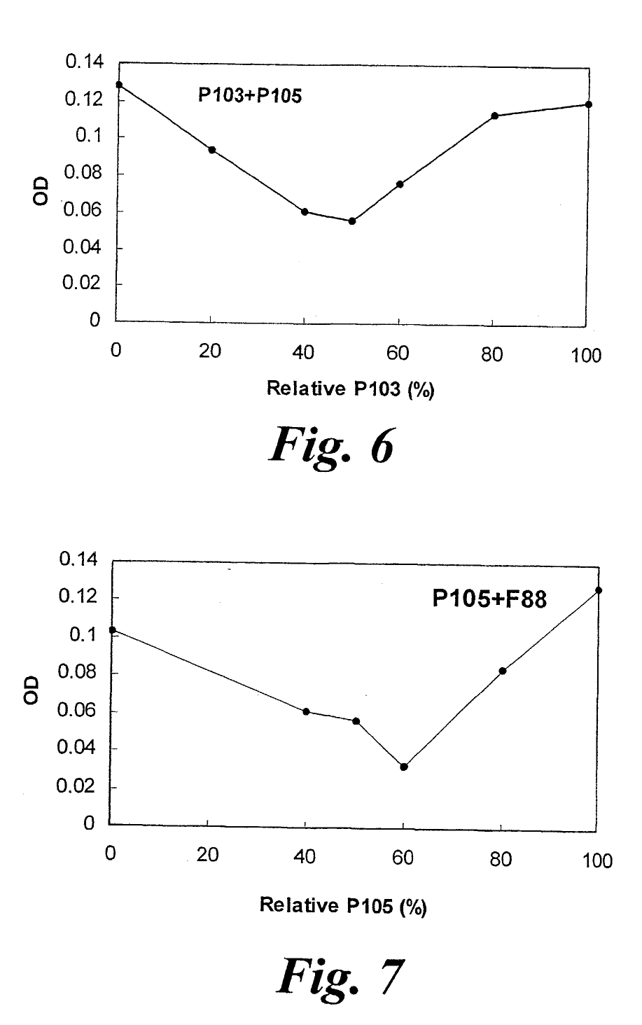

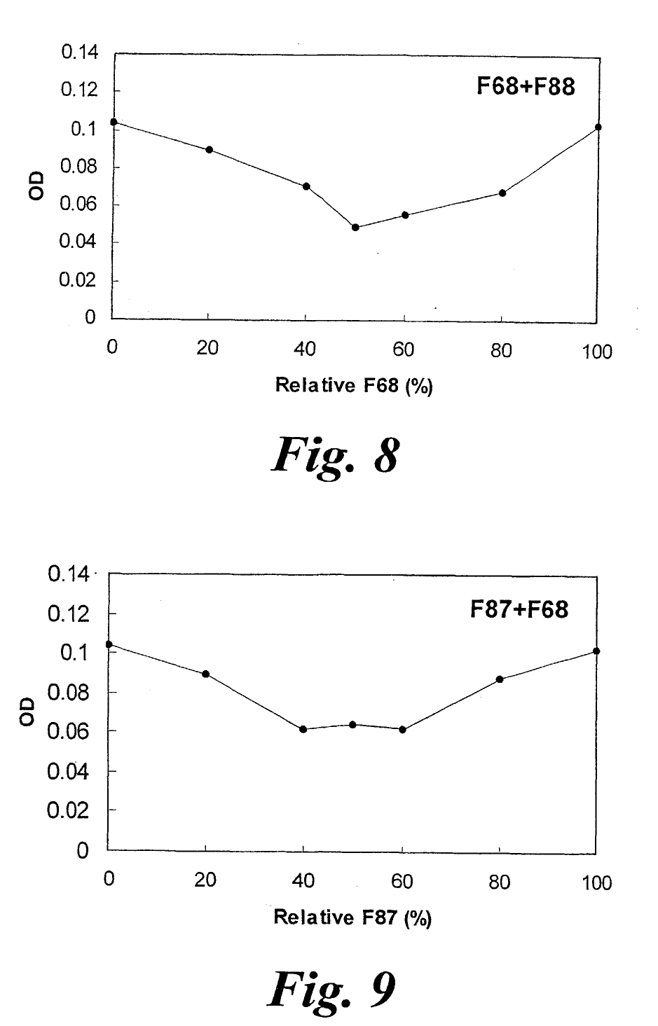

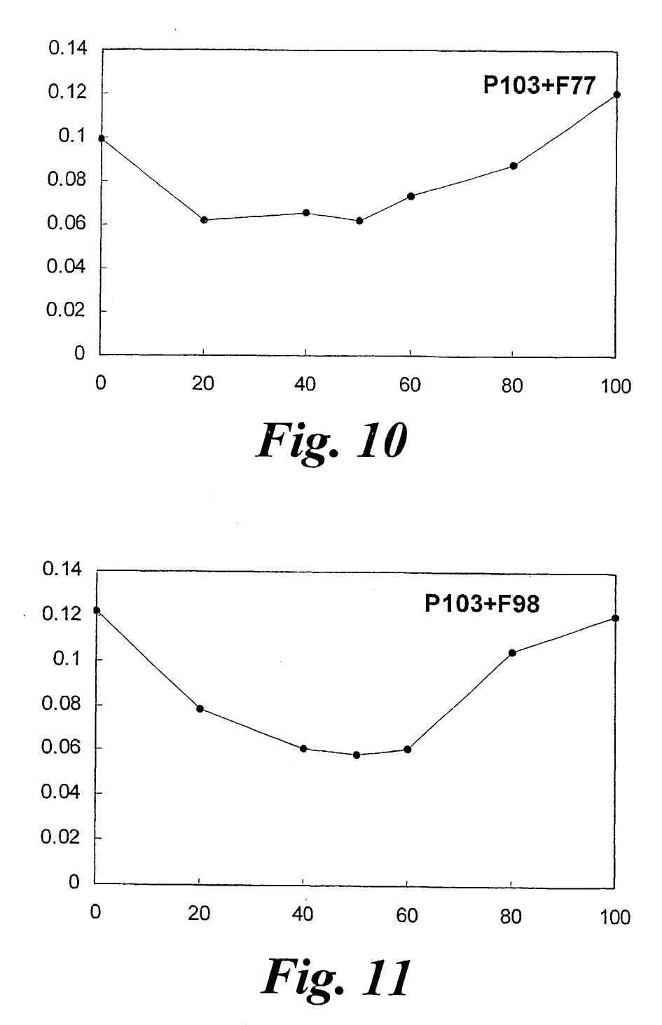

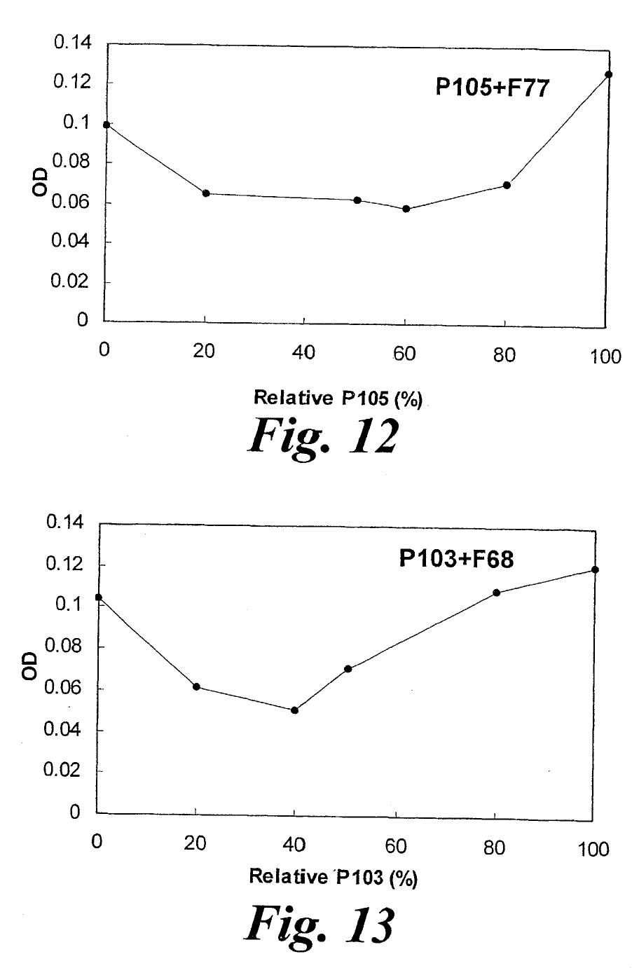

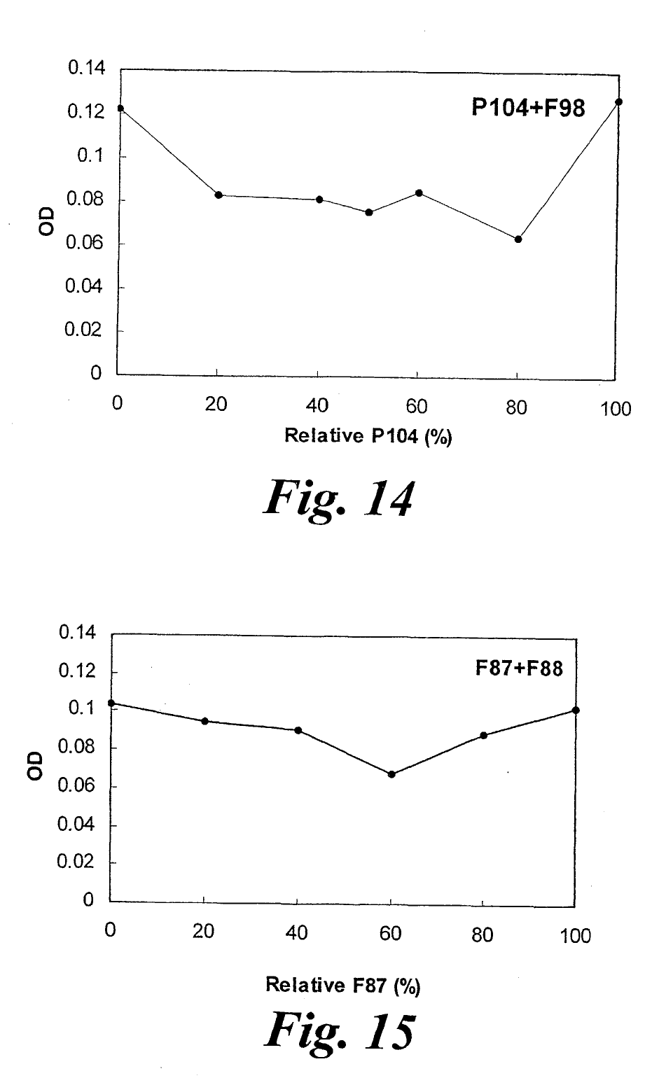

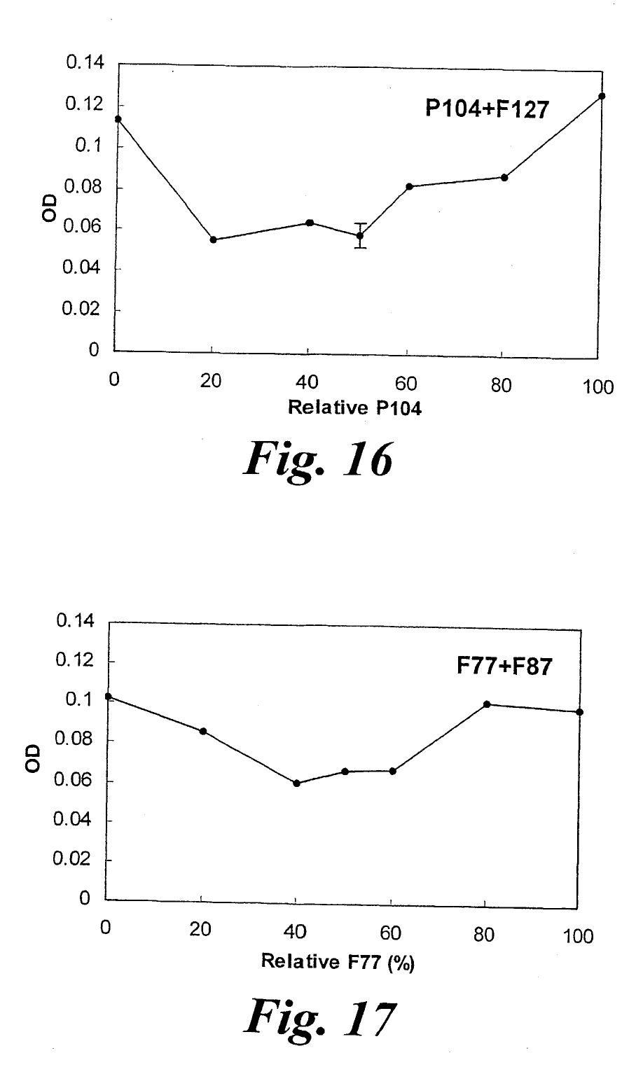

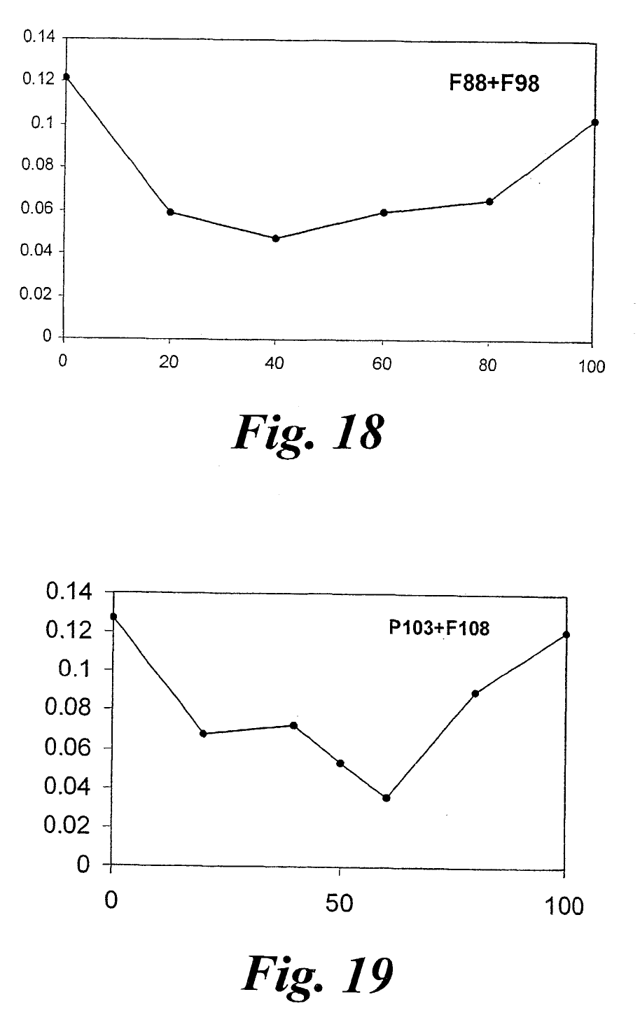

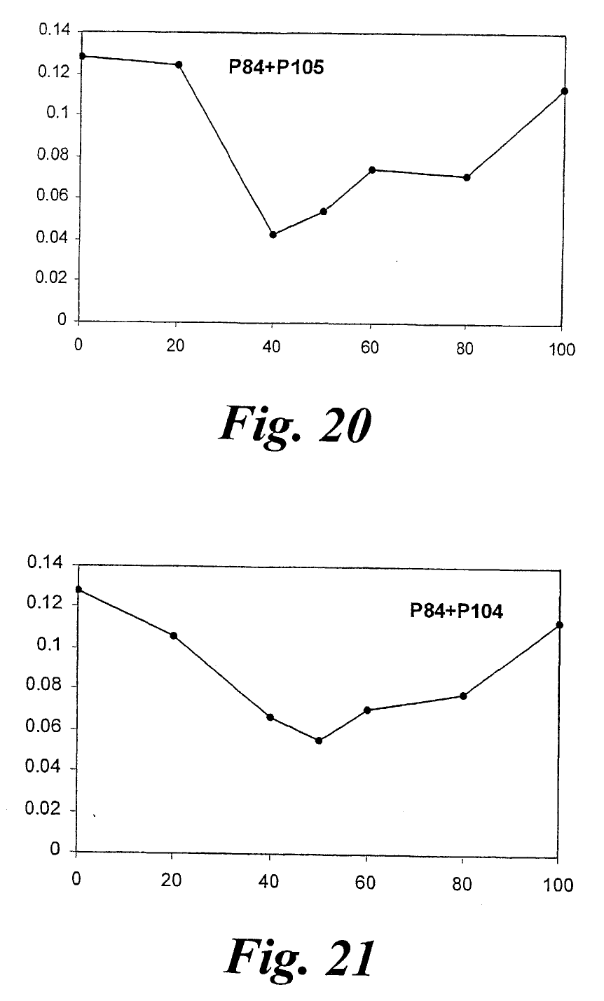

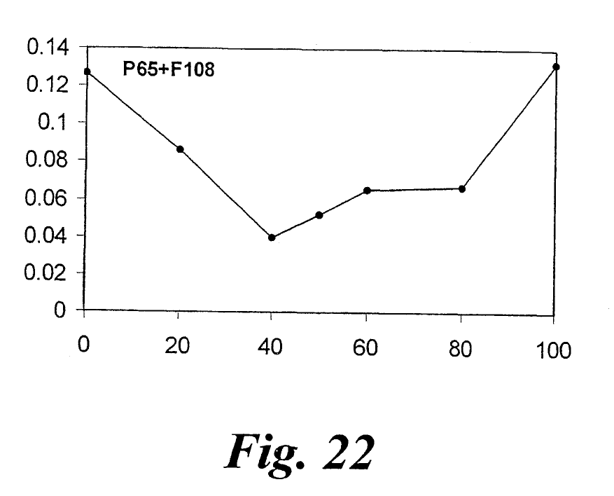

Results for this second set off experiments are shown in Tables 3 to 23. The results of Tables 3 to 23 are shown graphically in FIGS. 2 to 22 in which the figures on the vertical axis represent the observed optical density at 404 nm. It would have been expected that the additive effect of two poloxamers would be represented by a straight line in the attached Figures joining the points for 100% of one of the poloxamers to the point for 100% of the other poloxamer. As can be clearly seen from the Figures the actual curves obtained in the experiments carried out as above deviate from this straight line and the distance the curve is below that straight line for any combination of poloxamers is a measure of the amount of synergy being shown by that combination.

TABLE 3

| % | % | Observed | |
|---|---|---|---|
| F77 | F98 | OD | S.D. |
| 0 | 100 | 0.122 | 0.004 |
| 20 | 80 | 0.075 | 0.006 |
| 40 | 60 | 0.036 | 0.025 |
| 50 | 50 | 0.027 | 0.004 |
| 60 | 40 | 0.031 | 0.003 |
| 80 | 20 | 0.098 | 0.008 |
| 100 | 0 | 0.099 | 0.010 |

TABLE 4

| % | % | Observed | |
|---|---|---|---|
| F68 | F98 | OD | S.D. |
| 0 | 100 | 0.122 | 0.004 |
| 20 | 80 | 0.059 | 0.003 |
| 40 | 60 | 0.019 | 0.004 |
| 50 | 50 | 0.016 | 0.007 |
| 60 | 40 | 0.027 | 0.007 |
| 80 | 20 | 0.082 | 0.009 |
| 100 | 0 | 0.104 | 0.006 |

TABLE 5

| % | % | Observed | |
|---|---|---|---|
| F87 | F98 | OD | S.D. |
| 0 | 100 | 0.117 | 0.004 |
| 20 | 80 | 0.102 | 0.016 |
| 40 | 60 | 0.050 | 0.005 |
| 50 | 50 | 0.056 | 0.009 |
| 60 | 40 | 0.027 | 0.005 |
| 80 | 20 | 0.073 | 0.012 |
| 100 | 0 | 0.103 | 0.009 |

TABLE 6

| % | % | Observed | |
|---|---|---|---|
| F77 | F68 | OD | S.D. |
| 0 | 100 | 0.104 | 0.013 |
| 20 | 80 | 0.084 | 0.008 |
| 40 | 60 | 0.042 | 0.006 |
| 50 | 50 | 0.057 | 0.008 |
| 60 | 40 | 0.053 | 0.020 |
| 80 | 20 | 0.093 | 0.016 |
| 100 | 0 | 0.099 | 0.009 |

TABLE 7

| % | % | Observed | |
|---|---|---|---|
| F103 | F105 | OD | S.D. |
| 0 | 100 | 0.128 | 0.003 |
| 20 | 80 | 0.094 | 0.009 |
| 40 | 60 | 0.061 | 0.005 |
| 50 | 50 | 0.056 | 0.009 |
| 60 | 40 | 0.076 | 0.008 |
| 80 | 20 | 0.114 | 0.005 |
| 100 | 0 | 0.121 | 0.008 |

TABLE 8

| % | % | Observed | |
|---|---|---|---|
| F105 | F88 | OD | S.D. |
| 0 | 100 | 0.104 | 0.008 |
| 20 | 80 | 0.111 | 0.004 |
| 40 | 60 | 0.061 | 0.008 |
| 50 | 50 | 0.057 | 0.005 |
| 60 | 40 | 0.032 | 0.009 |
| 80 | 20 | 0.084 | 0.012 |
| 100 | 0 | 0.128 | 0.003 |

TABLE 9

| % | % | Observed | |
|---|---|---|---|
| F68 | F88 | OD | S.D. |
| 0 | 100 | 0.104 | 0.008 |
| 20 | 80 | 0.090 | 0.016 |
| 40 | 60 | 0.071 | 0.007 |
| 50 | 50 | 0.049 | 0.018 |
| 60 | 40 | 0.056 | 0.007 |
| 80 | 20 | 0.069 | 0.023 |
| 100 | 0 | 0.104 | 0.013 |

TABLE 10

| % | % | Observed | |
|---|---|---|---|
| F87 | F68 | OD | S.D. |
| 0 | 100 | 0.104 | 0.013 |
| 20 | 80 | 0.090 | 0.012 |
| 40 | 60 | 0.062 | 0.014 |
| 50 | 50 | 0.064 | 0.027 |
| 60 | 40 | 0.062 | 0.004 |
| 80 | 20 | 0.087 | 0.030 |
| 100 | 0 | 0.103 | 0.008 |

TABLE 11

| % | % | Observed | |
|---|---|---|---|
| F103 | F77 | OD | S.D. |
| 0 | 100 | 0.099 | 0.009 |
| 20 | 80 | 0.062 | 0.015 |
| 40 | 60 | 0.066 | 0.008 |
| 50 | 50 | 0.062 | 0.006 |
| 60 | 40 | 0.074 | 0.011 |
| 80 | 20 | 0.088 | 0.003 |
| 100 | 0 | 0.121 | 0.008 |

TABLE 12

| % | % | Observed | |
|---|---|---|---|
| F103 | F98 | OD | S.D. |
| 0 | 100 | 0.122 | 0.004 |
| 20 | 80 | 0.079 | 0.015 |
| 40 | 60 | 0.061 | 0.005 |
| 50 | 50 | 0.059 | 0.005 |
| 60 | 40 | 0.061 | 0.011 |
| 80 | 20 | 0.104 | 0.005 |
| 100 | 0 | 0.121 | 0.008 |

TABLE 13

| % | % | Observed | |
|---|---|---|---|
| F105 | F77 | OD | S.D. |
| 0 | 100 | 0.099 | 0.009 |
| 20 | 80 | 0.065 | 0.003 |
| 40 | 60 | 0.078 | 0.002 |
| 50 | 50 | 0.063 | 0.005 |
| 60 | 40 | 0.059 | 0.010 |
| 80 | 20 | 0.071 | 0.006 |
| 100 | 0 | 0.128 | 0.003 |

TABLE 14

| % | % | Observed | |
|---|---|---|---|
| F103 | F68 | OD | S.D. |
| 0 | 100 | 0.104 | 0.013 |
| 20 | 80 | 0.062 | 0.004 |
| 40 | 60 | 0.051 | 0.010 |
| 50 | 50 | 0.071 | 0.014 |
| 60 | 40 | 0.098 | 0.003 |
| 80 | 20 | 0.110 | 0.007 |
| 100 | 0 | 0.121 | 0.008 |

TABLE 15

| % | % | Observed | |
|---|---|---|---|
| F104 | F98 | OD | S.D. |
| 0 | 100 | 0.122 | 0.004 |
| 20 | 80 | 0.083 | 0.008 |
| 40 | 60 | 0.082 | 0.005 |
| 50 | 50 | 0.076 | 0.009 |
| 60 | 40 | 0.085 | 0.006 |
| 80 | 20 | 0.064 | 0.005 |
| 100 | 0 | 0.128 | 0.005 |

TABLE 16

| % | % | Observed | |
|---|---|---|---|
| F87 | F88 | OD | S.D. |
| 0 | 100 | 0.104 | 0.008 |
| 20 | 80 | 0.095 | 0.004 |
| 40 | 60 | 0.091 | 0.009 |
| 50 | 50 | 0.062 | 0.007 |
| 60 | 40 | 0.068 | 0.009 |
| 80 | 20 | 0.089 | 0.007 |
| 100 | 0 | 0.103 | 0.009 |

TABLE 17

| % | % | Observed | |
|---|---|---|---|
| F104 | F127 | OD | S.D. |
| 0 | 100 | 0.113 | 0.010 |
| 20 | 80 | 0.055 | 0.022 |
| 40 | 60 | 0.064 | 0.009 |
| 50 | 50 | 0.058 | 0.003 |
| 60 | 40 | 0.083 | 0.016 |
| 80 | 20 | 0.088 | 0.019 |
| 100 | 0 | 0.128 | 0.005 |

TABLE 18

| % | % | Observed | |
|---|---|---|---|
| F77 | F87 | OD | S.D. |
| 0 | 100 | 0.103 | 0.009 |
| 20 | 80 | 0.086 | 0.021 |
| 40 | 60 | 0.061 | 0.005 |
| 50 | 50 | 0.066 | 0.007 |
| 60 | 40 | 0.067 | 0.020 |
| 80 | 20 | 0.102 | 0.008 |
| 100 | 0 | 0.099 | 0.010 |

TABLE 19

| % | % | Observed | |
|---|---|---|---|
| F88 | F98 | OD | S.D. |
| 0 | 100 | 0.122 | 0.004 |
| 20 | 80 | 0.059 | 0.006 |
| 40 | 60 | 0.048 | 0.007 |
| 50 | 50 | 0.076 | 0.005 |
| 60 | 40 | 0.060 | 0.013 |
| 80 | 20 | 0.066 | 0.007 |
| 100 | 0 | 0.104 | 0.008 |

TABLE 20

| % | % | Observed | |
|---|---|---|---|
| F103 | F108 | OD | S.D. |
| 0 | 100 | 0.127 | 0.005 |
| 20 | 80 | 0.068 | 0.006 |
| 40 | 60 | 0.073 | 0.012 |
| 50 | 50 | 0.054 | 0.004 |
| 60 | 40 | 0.036 | 0.002 |
| 80 | 20 | 0.090 | 0.007 |
| 100 | 0 | 0.121 | 0.008 |

TABLE 21

| % | % | Observed | |
|---|---|---|---|
| F84 | F105 | OD | S.D. |
| 0 | 100 | 0.128 | 0.003 |
| 20 | 80 | 0.124 | 0.012 |
| 40 | 60 | 0.043 | 0.006 |
| 50 | 50 | 0.054 | 0.005 |
| 60 | 40 | 0.075 | 0.006 |
| 80 | 20 | 0.072 | 0.007 |
| 100 | 0 | 0.113 | 0.010 |

TABLE 22

| % | % | Observed | |
|---|---|---|---|
| F84 | F104 | OD | S.D. |
| 0 | 100 | 0.128 | 0.005 |
| 20 | 80 | 0.106 | 0.016 |
| 40 | 60 | 0.067 | 0.004 |
| 50 | 50 | 0.055 | 0.010 |
| 60 | 40 | 0.071 | 0.007 |
| 80 | 20 | 0.078 | 0.013 |
| 100 | 0 | 0.113 | 0.010 |

TABLE 23

| % | % | Observed | |
|---|---|---|---|
| F65 | F108 | OD | S.D. |
| 0 | 100 | 0.127 | 0.006 |
| 20 | 80 | 0.086 | 0.005 |
| 40 | 60 | 0.040 | 0.003 |
| 50 | 50 | 0.052 | 0.010 |
| 60 | 40 | 0.066 | 0.008 |
| 80 | 20 | 0.067 | 0.018 |
| 100 | 0 | 0.133 | 0.010 |

1. Use of two poloxamers selected from
a first group of poloxamers having a melting point in the range 48 to 58 degrees C. and having a HLB value in the range 22 to 29,
and a second group of poloxamers having a melting point in the range 27 to 35 degrees C. and having a HLB value in the range 8 to 17,
said poloxamers being selected from the same or different groups,
in the manufacture of a composition for inhibiting the adherence and formation of plaque and/or stains on the teeth.

2. Use as claimed in claim 1 wherein a poloxamer from the second group is used, and said poloxamer has a melting point in the range 30 to 35 degrees C. and and HLB value in the range 8 to 15.

3. Use as claimed in claim 1 or claim 2 wherein the poloxamers are present at 0.1% to 30% by weight of the total composition.

4. Use as claimed in any preceding claim wherein the poloxamers are present at 0.5 to 20% by weight of the total composition.

5. Use as claimed in any preceding claim wherein the poloxamers are present at 1 to 15% by weight of the total composition.

6. Use as claimed in any preceding claim wherein the ratio of the amounts of the two poloxamers is in the range 90:10 to 10:90.

7. Use as claimed in any preceding claim wherein the ratio of the amounts of the two poloxamers is in the range 80:20 to 20:80.

8. Use as claimed in any preceding claim wherein the ratio of the amounts of the two poloxamers is in the range 65:35 to 35:65.

9. Use as claimed in any preceding claim wherein the ratio of the amounts of the two poloxamers is in the range 60:40 to 40:60.

10. Use as claimed in any preceding claim wherein the ratio of the amounts of the two poloxamers is around 50:50.

11. Use as claimed in any preceding claim wherein said composition is a toothpaste, mouthrinse, toothgel, toothpowder, dental tablet or a dental gel.

12. A composition for inhibiting the adherence and formation of plaque and/or stains on the teeth, said composition containing two poloxamers selected from
a first group of poloxamers having a melting point in the range 48 to 58 degrees C. and having a HLB value in the range 22 to 29,
and a second group of poloxamers having a melting point in the range 27 to 35 degrees C. and having a HLB value in the range 8 to 17,
said poloxamers being selected from the same or different groups,
said composition being in the form of a toothpaste, toothgel, toothpowder, dental tablet or a dental gel.

13. A composition for inhibiting the adherence and formation of plaque and/or stains on the teeth, said composition containing two poloxamers selected from
a first group of poloxamers having a melting point in the range 48 to 58 degrees C. and having a HLB value in the range 22 to 29,
and a second group of poloxamers having a melting point in the range 27 to 35 degrees C. and having a HLB value in the range 8 to 17,
said poloxamers being selected from the same or different groups,
with the proviso that said two poloxamers are not Pluronic F87 and Pluronic P85.

14. A composition as claimed in claim 12 or claim 13, wherein the two poloxamers are selected from the group consisting of
Pluronic F77+Pluronic F98;
Pluronic F68+Pluronic F98;
Pluronic F87+Pluronic F98
Pluronic P123+Pluronic P77;
Pluronic P104+Pluronic F127;
Pluronic F77+Pluronic F68;
Pluronic P103+Pluronic P105;
Pluronic P105+Pluronic F88;
Pluronic P68+Pluronic F88;
Pluronic P87+Pluronic F68;
Pluronic P103+Pluronic F77;
Pluronic P103+Pluronic F98;
Pluronic P103+Pluronic P88;
Pluronic P105+Pluronic P77;
Pluronic P103+Pluronic F68;
Pluronic P104+Plumnic F98;
Pluronic P85+Pluronic P88;
Pluronic F87+Pluronic P88;
Pluronic P103+Pluronic P104;
Pluronic P65+Pluronic P108;
Pluronic P85+Pluronic P68;
Pluronic P85+Pluronic P77:
Pluronic P85+Pluronic F98;
Pluronic P85+Pluronic P84:
Pluronic P77+Pluronic F87;
Pluronic P88+Pluronic F98;
Pluronic P105+Pluronic F108;
Pluronic P84+Pluronic P105;
Pluronic P84+Pluronic P104; and
Pluronic P65+Pluronic P104

15. A composition as claimed in any one of claims 12 to 14, comprising a poloxamer from the second group, and said poloxamer has a melting point in the range 30 to 35 degrees C. and and HLB value in the range 8 to 15.

16. A composition as claimed in any one of claims 12 to 15 wherein the poloxamers are present at 0.1% to 30% by weight of the total composition.

17. A composition as claimed in any one of claims 12 to 16 wherein the poloxamers are present at 0.5 to 20% by weight of the total composition.

18. A composition as claimed in any one of claims 12 to 17 wherein the poloxamers are present at 1 to 15% by weight of the total composition.

19. A composition as claimed in any one of claims 12 to 18 wherein the ratio of the amounts of the two poloxamers is in the range 90:10 to 10:90.

20. A composition as claimed in any one of claims 12 to 19 wherein the ratio of the amounts of the two poloxamers is in the range 80:20 to 20:80.

21. A composition as claimed in any one of claims 12 to 20 wherein the ratio of the amounts of the two poloxamers is in the range 65:35 to 35:65.

22. A composition as claimed in any one of claims 12 to 21 wherein the ratio of the amounts of the two poloxamers is in the range 60:40 to 40:60.

23. A composition as claimed in any one of claims 12 to 22 wherein the ratio of the amounts of the two poloxamers is around 50:50.

24. A composition as claimed in claim 13 or claim 14 which is formulated as a toothpaste, mouthrinse, toothgel, toothpowder, dental tablet or a dental gel.

25. A method for inhibiting the adherence and formation of plaque and/or stains on the teeth, which method comprises administering to the teeth a composition containing two poloxamers selected from
a first group of poloxamers having a melting point in the range 48 to 58 degrees C. and having a HLB value in the range 22 to 29,
and a second group of poloxamers having a melting point in the range 27 to 35 degrees C. and having a HLB value in the range 8 to 17,
said poloxamers being selected from the same or different groups.

26. A method as claimed in claim 25 which is a cosmetic method for inhibiting the adherence and formation of stains on the teeth.
